(19) United States
(12) Patent Application Publication
(10) Pub. No.: US 2020/0264664 A1
(43) Pub. Date: Aug. 20, 2020

(54) PANEL DEVICE

(71) Applicant: LENOVO (SINGAPORE) PTE. LTD., SINGAPORE (SG)

(72) Inventors: Fumitake Mizoguchi, YOKOHAMA (JP); Takehito Yamauchi, YOKOHAMA (JP); Shigehiro Horiuchi, YOKOHAMA (JP); Sara Akiyama, YOKOHAMA (JP)

(73) Assignee: LENOVO (SINGAPORE) PTE. LTD., SINGAPORE (SG)

(21) Appl. No.: 16/505,729

(22) Filed: Jul. 9, 2019

(30) Foreign Application Priority Data
Feb. 14, 2019 (JP) 2019024403

(51) Int. Cl. G06F 1/16

(52) U.S. Cl. CPC G06F 1/1637; G06F 1/1616

(57) ABSTRACT

A panel device includes a panel; a display chassis surrounded by a bottom surface portion and a side wall portion, and having a space with a shape substantially identical to the shape of the panel, the display chassis being for accommodating the panel in the space; an adhesive member for adhering at least a part of the rear surface of the panel and the bottom surface portion of the display chassis, wherein the display chassis has a sloping face defined on an opposed portion of the side wall portion, the opposed portion being opposed to at least the side end portion of the panel.

### FIELD OF THE INVENTION

The present invention relates to a panel device.

### BACKGROUND OF THE INVENTION

As a panel device, for example, portable laptop personal computers have foldable display chassis (refer to, for example, Japanese Unexamined Patent Application Publication No. 2018-170371).

### SUMMARY OF THE INVENTION

A display chassis includes a panel for displaying images and a chassis for holding the panel. Around the panel of the display chassis, a bezel like a rectangular frame is disposed. When the width of the bezel of such a panel device is small, the panel is resultantly positioned close to the edge (the circumferential edge portion) of the chassis, which makes an impact caused when the device is dropped readily transmitted to the panel.

The present invention has been conceived to address the above-described problem, and an object of the present invention is to provide a panel device capable of preventing breakage of a panel even when the bezel width is small.

In order to address the above-described problem, a panel device according to an aspect of the present invention includes a panel; a chassis surrounded by a bottom surface portion and a side wall portion and having a space having a substantially identical shape of the panel, the chassis being for accommodating the panel in the space; and an adhesive member for adhering at least a part of the rear surface of the panel and the bottom surface portion of the chassis, wherein the chassis has a sloping face defined on an opposed portion of the side wall portion, the opposed portion being opposed to at least a side end portion of the panel.

In the above-described panel device, the sloping face may be inclined toward the outside of the chassis relative to the normal of the bottom surface portion, the bottom surface portion being opposed to the rear surface of the panel.

In the above-described panel device, the sloping face may be inclined relative to the normal at an angle ranging from 10° to 30°.

In the above-described panel device, the side end portion may be detached from the chassis.

In the above-described panel device, the panel may include a panel main body including a display device; a cover glass mounted in front of the panel main body; and a frame body mounted surrounding at least the edge portion of the cover glass, and the frame body may constitute the side end portion of the panel.

In the above-described panel device, the panel may include a panel main body having a display device; and a cover glass mounted in front of the panel main body, and the cover glass may constitute the side end portion of the panel.

In the above-described panel device, the side end portion of the panel may have a second sloping face that is substantially parallel to the sloping face.

The above-described aspect of the present invention can prevent breakage of a panel even when the bezel width is small.

### BRIEF DESCRIPTION OF THE DRAWINGS

FIG. 1 is a perspective view of an electronic apparatus 1 having a panel device in an embodiment of the present invention;

FIG. 2 is a cross sectional view of the area indicated by the reference character A in FIG. 1;

FIG. 3 illustrates an effect implemented by a sloping face 13a when a panel device a₁ in an embodiment of the present invention is dropped;

FIG. 4 illustrates, as a comparative example, a condition when a panel device a₁ without the sloping face 13a is dropped;

FIG. 5 is a cross sectional view of a panel device a₂ in one modified example of an embodiment of the present invention;

FIG. 6 is a cross sectional view of a panel device a₃ in one modified example of an embodiment of the present invention; and

FIG. 7 is a cross sectional view of a panel device a₄ in one modified example of an embodiment of the present invention.

### DETAILED DESCRIPTION OF THE INVENTION

An embodiment of the present invention will be described below referring to the drawings.

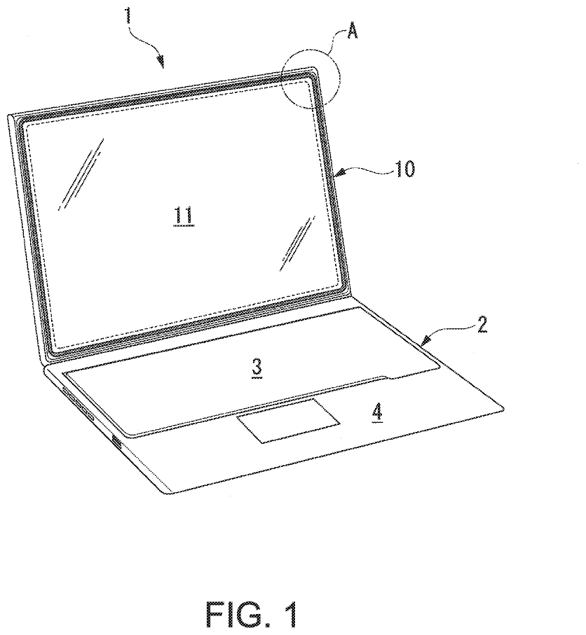

FIG. 1 is a perspective view of an electronic apparatus including a panel device in an embodiment of the present invention.

The electronic apparatus 1 illustrated in FIG. 1 is a clamshell-type laptop personal computer (a so-called notebook personal computer). The electronic apparatus 1 includes a system chassis 2 and a display chassis 10. The system chassis 2 and the display chassis 10 are linked to each other via a hinge, not illustrated, so as to be opened and closed.

The system chassis 2 has a keyboard assembly 3 and a palm rest area 4 formed on a side closer to a user than the keyboard assembly 3 is. As known, the system chassis 2 incorporates various electronic components, for example, including a processor, a motherboard, a wireless module, and a hard disk drive, all not illustrated here.

The display chassis 10 has a display module 11. The display module 11 includes, for example, a liquid crystal display or an organic EL display. The display surface of the display module 11 is a touch panel. The display chassis 10 can rotate by 360° around the hinge, not illustrated, as the center until it reaches the bottom surface side of the system chassis 2 (the rear surface side of the keyboard assembly 3), which rotation allows use like a tablet computer.

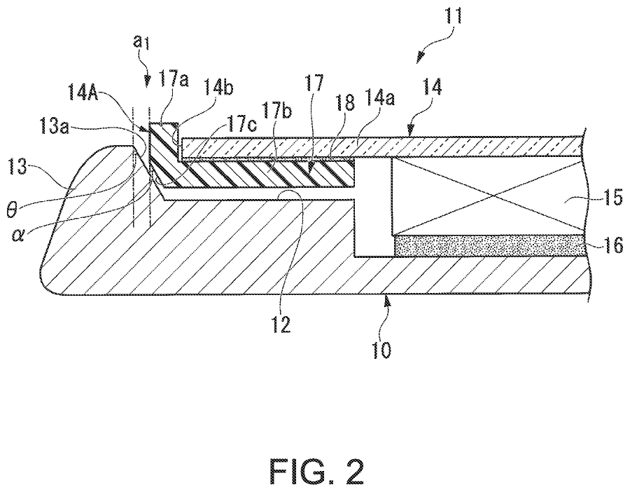

FIG. 2 is a cross sectional view of the area indicated by the reference character A in FIG. 1. In FIG. 2, the display module 11 is illustrated facing up on the paper of the drawing. The area indicated by the reference character A is one of the four corner edges of the display chassis 10. Any other edges (the circumferential edge portion) of the display chassis 10, not limited to the corner edge indicated by the reference character A, may have a structure similar to that illustrated in FIG. 2. Note that in this embodiment, a device including the display chassis 10 and the display module 11 illustrated in FIG. 2 is referred to as a panel device al.

The display chassis 10 (chassis) is made through die-casting light alloy, for example, aluminum alloy. The display chassis 10 has a bottom surface portion 12 and a side wall portion 13 that together define a bottomed recess where a panel 14 of the display module 11 is to be accommodated. That is, the display chassis 10 is surrounded by the bottom surface portion 12 and the side wall portion 13 and has a space having a substantially identical shape to that of the panel 14. The bottom surface portion 12 is opposed to at least a part of the rear surface of the panel 14 (the entire surface in this embodiment). The bottom surface portion 12 has a step that is formed along its circumferential edge portion such that a portion outside the step is higher (or shallower) than a portion inside, or surrounded by, the step.

The side wall portion 13 is formed standing on the circumference of the bottom surface portion 12 so as to have such a height that enables accommodating the display module 11. The side wall portion 13 is opposed to a side end portion 14A, to be described later, of the panel 14 of the display module 11 in a direction along the panel surface of the panel 14. The side wall portion 13 has a sloping face 13a defined on an opposed portion (an inside wall surface) that is opposed to the side end portion 14A of the panel 14.

The sloping face 13a is inclined toward the outside of the display chassis 10 relative to the normal of the bottom surface portion 12 of the display chassis 10. That is, the sloping face 13a is a surface inclined outward relative to a line, as a reference, orthogonal to the bottom surface portion 12 of the display chassis 10. Alternatively, the sloping face 13a can be rephrased as a surface that is situated so as to gradually depart from the side end portion 14A of the panel 14 as going from the rear toward the front (the front surface) of the panel 14. The inclination angle of the sloping face 13a is identified as θ.

The display module 11 has the panel 14, which is accommodated in the display chassis 10. The panel 14 includes a panel main body 15 including a display device, a cover glass 14a mounted in front of the panel main body 15, and a bezel frame 17 (a frame body) mounted surrounding at least the edge portion of the cover glass 14a. The panel main body 15 is disposed at the rear of the cover glass 14a, and includes, for example, a light source, such as an LED, and a liquid crystal driving circuit, or the like. The panel main body 15 is disposed in a position more inward than the step of the bottom surface portion 12 of the display chassis 10 and fixed to the bottom surface portion 12 via an adhesive member 16. Examples of the adhesive member 16 can include double stick tapes.

The cover glass 14a is made using a glass plate, for example. In the case of the panel 14 that is a touch panel, as is in this embodiment, for example, a transparent electrode film or a protection cover (not illustrated in the drawings) is attached on the rear surface of the glass plate (the front surface of the display device). The side end face 14b of the cover glass 14a is a face parallel to the normal of the bottom surface portion 12 of the display chassis 10, and has a positional relationship of being opposed to the side wall portion 13 of the display chassis 10.

Around this cover glass 14a, the bezel frame 17, made of plastic, is mounted surrounding the cover glass 14a. The bezel frame 17 has an L-shaped cross section, in which one linear portion of the L-shape makes an abutment portion 17a, and the other linear portion makes a mounting portion 17b. The abutment portion 17a is positioned so as to be opposed to the side end face 14b of the cover glass 14a and also so as to be able to abut on the sloping face 13a of the side wall portion 13. That is, the abutment portion 17a is disposed between the side end face 14b of the cover glass 14a and the sloping face 13a of the side wall portion 13.

The mounting portion 17b is disposed on the rear surface side of the circumferential edge portion of the cover glass 14a and fixed on the rear surface side of the cover glass 14a via an adhesive member 18. Examples of the adhesive member 18 include double stick tapes. Such a bezel frame 17 is opposed to the side wall portion 13 of the display chassis 10 via the abutment portion 17a along the circumferential edge portion of the cover glass 14a and also opposed to the bottom surface portion 12 of the display chassis 10 via the mounting portion 17b. That is, the bezel frame 17 can be described as constituting the side end portion 14A of the panel 14.

On the outer surface of a portion of the bezel frame 17 at a position where the respective linear portions constituting the abutment portion 17a and the mounting portion 17b join to each other, a second sloping face 17c is defined. The second sloping face 17c is substantially parallel to the sloping face 13a of the side wall portion 13 defined on the display chassis 10. That is, the second sloping face 17c is formed straddling the abutment portion 17a and the mounting portion 17b. In other words, the second sloping face 17c can be described as being formed at a corner portion defined by the abutment portion 17a and the mounting portion 17b. Alternatively, the second sloping face 17c can be described as a surface that is a lower end portion of the outer surface of the abutment portion 17a, the surface being inclined toward the inside of the display chassis 10. The inclination angle of the second sloping face 17c is identified as α. The inclination angle α is preferred to be equal to the inclination angle θ, though the inclination angle α substantially equal to the inclination angle θ is acceptable. That is, for example, if the difference is about ±3°, the second sloping face 17c can be said “substantially equal”, as mentioned above, to the sloping face 13a.

Note that although FIG. 2 illustrates a space between the sloping face 13a of the display chassis 10 and the second sloping face 17c of the bezel frame 17, between the side end face 14b of the cover glass 14a and the abutment portion 17a of the bezel frame 17, and between the bottom surface portion 12 of the display chassis 10 and the mounting portion 17b of the bezel frame 17, such spaces are illustrated only for clear distinction between the respective members. In a physical device, the respective members may abut on each other except that the side end portion 14A of the panel 14 is detached from the display chassis 10 so that sliding to be described later is possible.

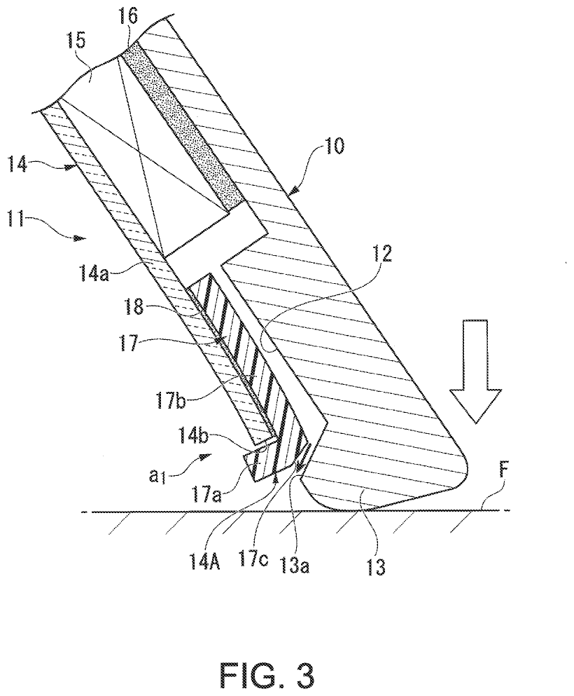

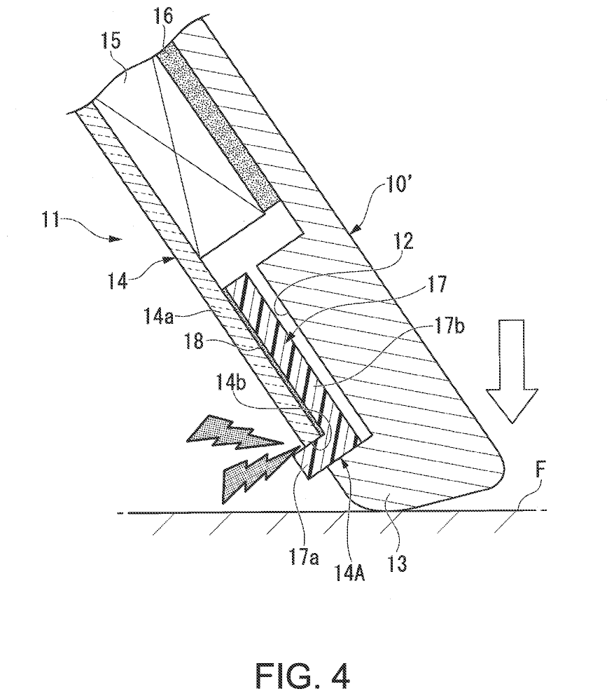

FIG. 3 illustrates an effect implemented by the sloping face 13a when the panel device a1 in an embodiment of the present invention is dropped. FIG. 4 illustrates a condition as a comparative example when a panel device a1 without the sloping face 13a is dropped. Specifically, FIG. 3 and FIG. 4 illustrate, for example, a situation in which the electronic apparatus 1 illustrated in FIG. 1 is dropped while being used like a tablet computer, with the display chassis 10 rotated toward the rear surface side of the system chassis 2, such that an corner edge of the display chassis 10 bumps against the floor F.

As illustrated in FIG. 3, with the panel device a₁ dropped, an impact caused at the side wall portion 13 of the display chassis 10 is applied to the cover glass 14a via the abutment portion 17a of the bezel frame 17. In the above, the abutment portion 17a of the bezel frame 17 slides along the inclined sloping face 13a, defined on the side wall portion 13, to thereby cause the side end face 14b and its adjoining portion of the cover glass 14a to move away from the bottom surface portion 12 side of the display chassis 10.

That is, the sliding on the sloping face 13a causes an energy in the glass plate horizontally compressing direction applied to the side end face 14b of the cover glass 14a to escape as an energy in a bending direction that causes the cover glass 14a to bend. Hence, the cover glass 14a deforms such that the side end face 14b and its adjoining portion flex, as illustrated. In this manner, as the sliding on the sloping face 13a enables reduction in the impact force applied to the side end face 14b of the cover glass 14a, the cover glass 14a can be saved from being broken. That is, it is possible to prevent breakage of the cover glass 14a even when the bezel width of the panel device a₁ is small.

Further, since the inclination angle α of the second sloping face 17c formed on the bezel frame 17 is equal to the inclination angle θ of the sloping face 13a of the side wall portion 13 in the panel device a1 in this embodiment, the abutment portion 17a of the bezel frame 17 can slide more smoothly on the sloping face 13a of the side wall portion 13.

On the contrary, the inclination angle θ of the sloping face 13a of the side wall portion 13 of the display chassis 10′ illustrated in FIG. 4 is zero. In the case of this display chassis 10′, when the corner portion of the display chassis 10′ bumps against the floor F, the impact caused on the side wall portion 13 (an energy in the glass plate horizontally compressing direction) is all applied to the side end face 14b of the cover glass 14a without reduction due to the absence of the sloping face 13a on the side wall portion 13. Consequently, the cover glass 14a is readily broken.

A preferred inclination angle θ of the sloping face 13a of the side wall portion 13 will be described below.

Preferably, the inclination angle 6 illustrated in FIG. 2 is 10° or more and 60° or less. With the inclination angle θ being 10° or more, the sliding on the sloping face 13a causes the side end face 14b and its adjoining portion of the cover glass 14a to flex, so that the cover glass 14a can be saved from being broken. Further, formation of the inclination angle θ being 10° or more enables clear distinction from a draft angle (θ=about 1.5° to 3.0°) for formation of the display chassis 10. Further, the inclination angle θ being 60° or less enables formation of a small width of the side wall portion 13, that is, a small bezel width of the panel device al.

More preferably, the inclination angle θ is 10° or more and 45° or less. With the inclination angle θ being 45° or less, the sloping face 13a of the side wall portion 13, which is seen around the panel 14, (that is, the gap between the side wall portion 13 and the bezel frame 17, the gap being seen on the front surface) results in thin and hardly seeable. This improves the appearance of the panel device a₁.

Further preferably, the inclination angle θ is 30° or more and 45° or less. With the inclination angle θ being 30° or more, the sliding on the sloping face 13a can cause the side end face 14b and its adjoining portion of the cover glass 14a to flex sufficiently. This enables more reliable prevention of breakage of the cover glass 14a.

The above-mentioned preferred lower limits of the inclination angle θ are based on the result of simulation in a drop test of the display chassis 10 with the inclination angle θ of the sloping face 13a set to 0°, 10°, 20°, and 30°, respectively. This simulation is to analyze whether the cover glass 14a is damaged when the display chassis 10 is dropped from a predetermined height such that a corner edge of the display chassis 10 bumps against the ground. The result shows that, with the inclination angle θ being 0°, the cover glass 14a is damaged, and that, with the inclination angles θ being 10°, 20°, and 30°, respectively, the cover glass 14a is not damaged, and verifies that the energy in the glass plate horizontally compressing direction is reduced in which the amount of reduction increases in the order of 10°, 20°, and 30°.

In other words, the sloping face 13a is preferred to be inclined by an angle ranging from 10° to 30° relative to the normal of the bottom surface portion 12.

Although an embodiment of the present invention has been described above with reference to the drawings, specific structures are not limited to those described in the above embodiment, and any designs not departing from the gist of the present inventions are included. Further, the respective structures described in the embodiment described above can be arbitrarily combined provided no contradiction is caused.

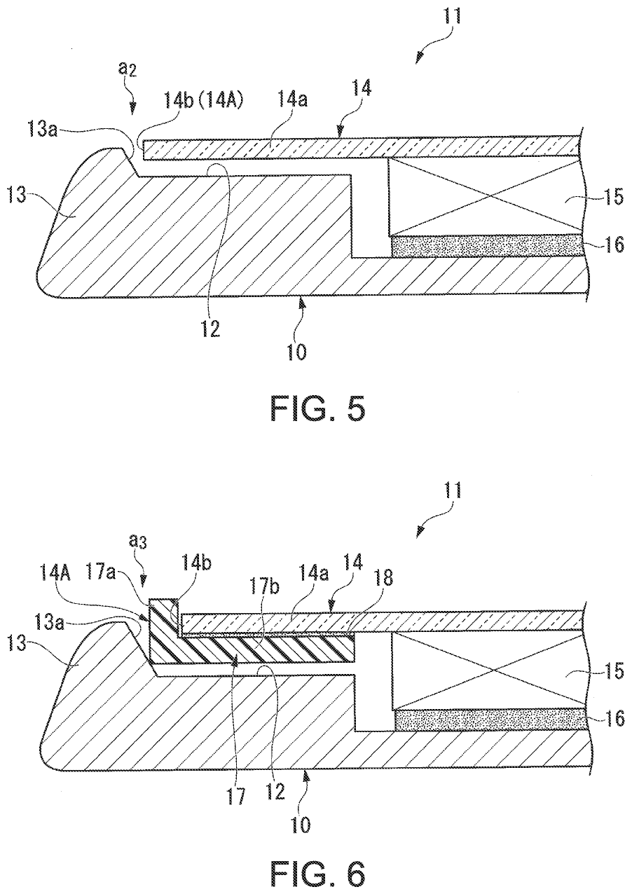

For example, structures such as illustrated in FIG. 5 to FIG. 7 are employable.

FIG. 5 is a cross sectional view of a panel device a₂ in a modified example of the embodiment of the present invention.

The panel device a₂ illustrated in FIG. 5 is identical to the panel device a₁ illustrated in FIG. 2 described above except for the absence of the bezel frame 17 of the panel device a₁. That is, if the bezel frame 17 is unnecessary for the cover glass 14a, the side end face 14b of the cover glass 14a constitutes the side end portion 14A of the panel 14, and directly abuts on the sloping face 13a of the side wall portion 13.

This structure as well causes the side end face 14b and its adjoining portion of the cover glass 14a to flex as a result of sliding on the sloping face 13a when the panel device a₂ is dropped. Hence, an impact force to be applied to the side end face 14b of the cover glass 14a is reduced, so that the cover glass 14a can be saved from being broken.

FIG. 6 is a cross sectional view of a panel device a₃ in a modified example of the embodiment of the present invention.

The panel device a₃ illustrated in FIG. 6 is identical to the panel device a₁ illustrated in FIG. 2 described above except for the absence of the second sloping face 17c on the bezel frame 17 of the panel device a₁. In the case of this bezel frame 17, a corner of the bezel frame 17 abuts on the sloping face 13a of the side wall portion 13.

This structure as well causes the side end face 14b and its adjoining portion of the cover glass 14a to flex as a result of sliding on the sloping face 13a when the panel device a₃ is dropped. Hence, an impact force to be applied to the side end face 14b of the cover glass 14a is reduced, so that the cover glass 14a can be saved from being broken.

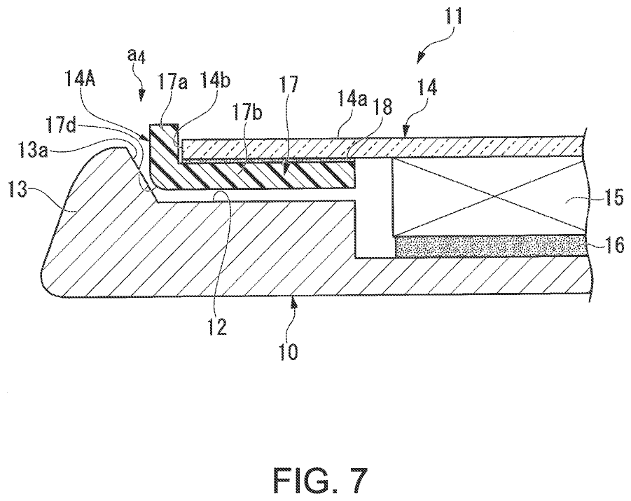

FIG. 7 is a cross sectional view of a panel device a4 in a modified example of the embodiment of the present invention.

The panel device a₄ illustrated in FIG. 7 is identical to the panel device a₁ in FIG. 2 described above except that the second sloping face 17c of the bezel frame 17 of the panel device al is a rounded face 17d. In this case, the rounded face 17d of the bezel frame 17 is to abut on the sloping face 13a of the side wall portion 13.

This structure as well causes the side end face 14b and its adjoining portion of the cover glass 14a to flex as a result of sliding on the sloping face 13a when the panel device a4 is dropped. Hence, an impact force to be applied to the side end face 14b of the cover glass 14a is reduced, so that the cover glass 14a can be saved from being broken.

Note that, for example, in the description of the above embodiment, a laptop personal computer has been referred to as an example of application of a panel device, but the present invention is not limited to laptop personal computers, and may be applied to tablet computers, display apparatuses alone, or other types of panel devices, such as electric bulletin boards or signboards having built-in panels.

1. A panel device, comprising:
a panel;
a chassis surrounded by a bottom surface portion and a side wall portion, and having a space with a shape substantially identical to that of the panel, the chassis accommodating the panel in the space; and
an adhesive member adhering at least a part of a rear surface of the panel and the bottom surface portion of the chassis,
wherein:
the chassis has a sloping face on an opposed portion of the side wall portion, the opposed portion being opposed to at least a side end portion of the panel.

2. The panel device according to claim 1, wherein the sloping face is inclined towards an outside of the chassis relative to a normal of the bottom surface portion, the bottom surface portion being opposed to the rear surface of the panel.

3. The panel device according to claim 2, wherein the sloping face is inclined relative to the normal at an angle ranging from 10° to 30°.

4. The panel device according to claim 1, wherein the side end portion is detached from the chassis.

5. The panel device according to claim 1, wherein:
the panel includes at least a panel main body including a display device, a cover glass in front of the panel main body, and a frame body surrounding at least an edge portion of the cover glass, and
the frame body constitutes the side end portion of the panel.

6. The panel device according to claim 1, wherein:
the panel includes at least a panel main body including a display device, and a cover glass in front of the panel main body, and
the cover glass constitutes the side end portion of the panel.

7. The panel device according to claim 1, wherein the side end portion of the panel has a second sloping face that is substantially parallel to the sloping face that is substantially parallel to the sloping face.
